(19) United States
(12) Patent Application Publication
(10) Pub. No.: US 2006/0186106 A1
(43) Pub. Date: Aug. 24, 2006

(54) Heat transfer apparatus

(76) Inventors: Hugh C. Neville, Barrington, RI (US); Hugh C. Neville II, Barrington, RI (US)

Correspondence Address: SALTER & MICHAELSON;THE HERITAGE BUILDING, 321 SOUTH MAIN STREET, PROVIDENCE, RI, 029037128, US

(21) Appl. No.: 11/359,785

(22) Filed: Feb. 22, 2006

Related U.S. Application Data
(60) Provisional application No. 60/655,512, filed on Feb. 23, 2005.

(51) Int. Cl. B02C 11/08; H05B 3/02; B30B 15/34; B32B 37/00

(52) U.S. Cl. 219/243; 100/320; 100/92; 156/381

(57) ABSTRACT

A heat transfer press that includes an upper part which is movable between open and closed conditions; a lower part; a flexible diaphragm; a glass sheet member having an electrically conductive coating on its surface; first and second elongate, spaced, electrically conductive bus bars on the electrically conductive coating and electrically connected thereto; a reflective heat insulating coating over the electrically conductive coating and air evacuating means for evacuating air from between the upper part and the lower part of the press when the upper part is in its closed condition on the lower part. An electric current is passed through the electrically conductive coating, for enabling the glass sheet member to be heated by an electric current to provide heat to sheet workpiece material in the press while the reflective heat insulating coating redirects heat toward the sheet workpiece material to enhance the heating process.

### CROSS REFERENCE TO RELATED APPLICATIONS

This application claims priority under 35 U.S.C. §119(e) to co-pending U.S. Provisional Patent Application Ser. No. 60/655,512, entitled HEAT TRANSFER APPARATUS, filed Feb. 23, 2005.

### TECHNICAL FIELD

The present invention relates in general to an improved heat transfer press. More particularly, the present invention relates to a heat transfer press that employs a heated glass platen in combination with the application of a vacuum.

### BACKGROUND OF THE INVENTION

A number of different types of heat transfer presses are known in the prior art. One such press is referred to as a sublimation heat transfer press. This is comprised of an upper and a lower rigid part or platen with the upper part being movable between open and closed positions. The upper part is normally a heated metal platen that develops heat on the platen surface which when pressed in contact with the lower platen, using either mechanical or hydraulic pressure, transfers dye sublimated images that have been digitally, screen or offset printed onto transfer paper to polyester coated fabrics, polyester films, polyester coated ceramic tiles and many other polyester coated substrates. One of the drawbacks to these metal platen transfer presses is that the metal tends to expand and contract and thus creates uneven, warped and consequently non-flat surfaces, particularly under high temperatures. This also creates uneven heated areas or “hot spots.” These “hot spots” can create inconsistencies in the final fabric or film.

Another transfer press is described in U.S. Pat. No. 5,171,970 to Chichlowski. A drawback with this press is the inability to provide a sufficient level of uniform heat in carrying out the transfer process.

Accordingly, it is an object of the present invention to provide an improved heat transfer press apparatus.

Another object of the present invention is to provide an improved heat transfer apparatus particularly for a sublimation heat transfer process.

### SUMMARY OF THE INVENTION

In accordance with the present invention there is provided an improved sublimation heat transfer press that uses a high heat glass platen or sheet and a flexible elastic rubber or plastic blanket or diaphragm. This apparatus is employed in concert with an air evacuation system that typically employs a vacuum pump to create a relatively high and uniform pressure. This flexes or presses the diaphragm against the dye sublimated printed paper and polyester medium to which it is being transferred. The system of the present invention is meant to replace mechanical or hydraulic pressure system used in conventional sublimation heat transfer presses.

In accordance with another aspect of the present invention, there is provided a sublimation heat transfer press for transferring a latent image from a dye sublimated printed medium to a receiver medium. The heat transfer press comprises a first platen and a second platen between which is disposed the media and adapt to have open and closed positions between the platens. The first platen includes a heatable glass sheet having a medium contact side and an opposite outer side. The glass sheet has an electrically conductive coating at the outer side. Bus bars connect an electrical source to the electrically conductive coating of the glass sheet. On the glass sheet there is also provided a reflective heat insulating coating over the electrically conductive coating. The heat transfer press also includes a flexible diaphragm and an air evacuating means for evacuating air from between the platens in the closed position thereof. An electric current is passed through the electrically conductive coating for enabling the glass sheet to be heated by the electric current to provide heat to the media in the press while the reflective heat insulating coating redirects heat toward the media to enhance the heating process. The flexible diaphragm is able to be flexed against the sheet media to provide substantially even pressure over the surface of the media while heat is applied thereto from the electrically conductive glass sheet.

In accordance with still other aspects of the present invention, the electrically conductive coating may be a layer of an electrically conductive metal oxide. The diaphragm may have associated therewith a peripheral gasket that seals with the glass sheet. In one version the first platen is a lower platen, the second platen is an upper platen, the diaphragm is mounted on the lower platen and the electrically conductive glass sheet is mounted on the upper platen. In an alternate arrangement the first platen is a lower platen, the second platen is an upper platen, the diaphragm is mounted on the upper platen, and an electrically conductive glass sheet is mounted on the lower platen. The air evacuating means may comprise a vacuum pump. The reflective heat insulating coating preferably comprises an opaque, preferably black, electrically and thermally insulating layer.

In accordance with still further aspects of the present invention, there is provided a heat transfer press that comprises an upper part which is movable between open and closed positions, a lower part, a flexible diaphragm, a glass sheet member having an electrically conductive coating on its surface, first and second elongate, spaced electrically conductive bus bars on said electrically conductive coating and electrically connected thereto, a reflective heat insulating coating over said electrically conductive coating, and an air evacuating means for evacuating air from between the upper part and the lower part of the press when the press is in its closed position. An electric current is passed through the electrically conductive coating for enabling the glass sheet member to be heated by the electric current to provide heat to the sheet work piece material in the press while the reflective heat insulating coating redirects heat toward the sheet work piece material to enhance the heating process. The diaphragm is able to be flexed against the sheet work piece material to provide substantially even pressure over the surface of the sheet work piece material while heat is applied to the sheet work piece material from the electrically conductive glass sheet member.

### DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1. is a perspective view of the heat transfer apparatus of the present invention in its open position;

FIG. 2 is a perspective view of the heat transfer apparatus in its closed position;

FIG. 3 is a perspective view illustrating the apparatus base and lower platen;

FIG. 4 is a plan view of the lower platen;

FIG. 5 is a fragmentary perspective view of the lower platen illustrating a vacuum port;

FIG. 6 is a cross-sectional view taken along line 6-6 of FIG. 5;

FIG. 7 is a bottom view of the lower platen illustrating the connection of vacuum lines;

FIG. 8 is a fragmentary enlarged view of the details of the vacuum lines;

FIG. 9 is an exploded perspective view of the upper platen construction;

FIG. 10 is a cross-sectional view taken along line 10-10 of FIG. 9;

FIG. 11 is a cross-sectional view taken along line 11-11 of FIG. 9;

FIG. 12 is a cross-sectional view of the two components of FIGS. 10 and 11 fitted together;

FIG. 13 is a plan view of the upper platen illustrating in dotted outline the electrical connections and bus bars;

FIG. 14 is a perspective view of the heat transfer apparatus in its open position illustrating the sheet work piece material in place;

FIG. 15 is a perspective view of the heat transfer apparatus of FIG. 14 in its closed position;

FIG. 16 is a cross-sectional view taken along line 16-16 of FIG. 15;

FIG. 17 is a plan view of an alternate embodiment of the present invention using a peripheral heating strip;

FIG. 18 is a plan view of still another embodiment of the present invention using a heating blanket; and

FIG. 19 is a partial cross-section of the alternate embodiment of FIG. 18.

### DETAILED DESCRIPTION OF THE PREFERRED EMBODIMENT

The apparatus and technique of the present invention employs a high heat glass platen in combination with a flexible elastic rubber or plastic blanket or diaphragm, and further in combination with an air evacuation system for providing a uniform pressure on the diaphragm against the dye sublimated printed paper and receiver medium. The material “receiver” to which the sublimation ink transfer is to be made is generally placed on the lower platen. In one embodiment a rigid board such as a high temperature resistant board may be wrapped with a high temperature resistant fabric such as a polyester or preferably a nomex cloth which has been permanently adhered to the high temperature resistant or similar board. The paper that has been imaged with the sublimation ink is then interfaced with the “receiver” and a second layer of a high temperature resistant fabric is then rolled over the sublimation and receiver sandwich. This may be rolled manually or automatically placed over the sandwich. The upper glass platen is lowered and clamped to the lower rigid platen that supports the diaphragm. A peripheral gasket is preferably provided that is secured at the outer edge perimeter of the diaphragm. A seal is created so that the air between the diaphragm and the heated glass platen can be evacuated. A vacuum pressure in excess of 20″ is used. The sublimated paper and “receiver” are retained in intimate and absolutely flat contact under uniform pressure for at least 3½ minutes and preferably for 6 or 8 minutes. The time period will depend on the particular receiving material. The glass platen heating is preferably controlled at a temperature of approximately 180° C. The operating temperature is preferably in a range of 160° C. to 180° C. The vacuum is then released and the top platen is unclamped and raised. This may occur with the use of gas pistons for controlling between the loading and unloading positions. The high heat resistant fabric is quickly rolled away from the sandwiched material and the sublimation paper is peeled from the “receiver” medium with the transfer of the inked image having been totally accomplished.

The glass sheet or platen has an electrically conductive coating that enables the glass to be heated at a constant uniform temperature over its entire surface. One side of the glass is provided with an opaque, preferably black, coating that provides both thermal and electrical insulation. This coating reflects heat toward the materials inside the press which increases the efficiency of the press and preserves energy at the same time. Unlike a metal platen press, which tends to expand and create uneven, warped and consequently non-flat surfaces under high heat, and generally also has uneven heated areas, the glass platen stays substantially flat over its entire heating area and thus provides a uniform temperature of platen heating. This also makes it possible to create presses of relatively large size. Typical platen configurations that have been used in accordance with the present invention have been 60″×100″ and 50″×72″. However, larger or smaller size platen configurations are contemplated as falling within the scope of the present invention.

The particular embodiment that is illustrated herein has the glass platen on the top and the flexible diaphragm on the bottom. However, in an alternate embodiment of the invention, the glass platen may be on the lower part of the apparatus and the diaphragm on the upper part thereof. Also, the peripheral gasket may be attached with either platen. The press incorporates a rubber or synthetic gasketing material to effect a seal when the upper and lower platens are closed. The system that is described also incorporates an air evacuating element normally including a vacuum pump. The high temperature glass is preferably further insulated with appropriate materials to prevent overheating of the metal frame components and with the preferred use of a top cover sheet made from metal or another rigid substance to protect the glass member from breakage.

In accordance with the present invention, as to be described hereinafter, the heat transfer apparatus is controlled from a controller. The operator can control the process with the use of electronic devices to control, for example, the temperature of the glass element, the sequential operating cycle, and the vacuum system. The controller or control box preferably has the capability of programming a number of different cycles. It automatically cycles a pre-selected timed transfer cycle. At the present time, there are in excess of thirty receiver products all of which require a somewhat different transfer cycle, and that cycle can be programmed into the control box.

The electrically conductive glass sheet has an electrically conductive coated layer of conductive metal oxide on its surface, two elongated spaced electrical buss bars on the electrically conductive coating and electrically connected thereto, whereby, an electric current is passed through the electrically conductive coating and enables the glass sheet member to be heated by an electric current to provide the heat to the sublimation materials in the press.

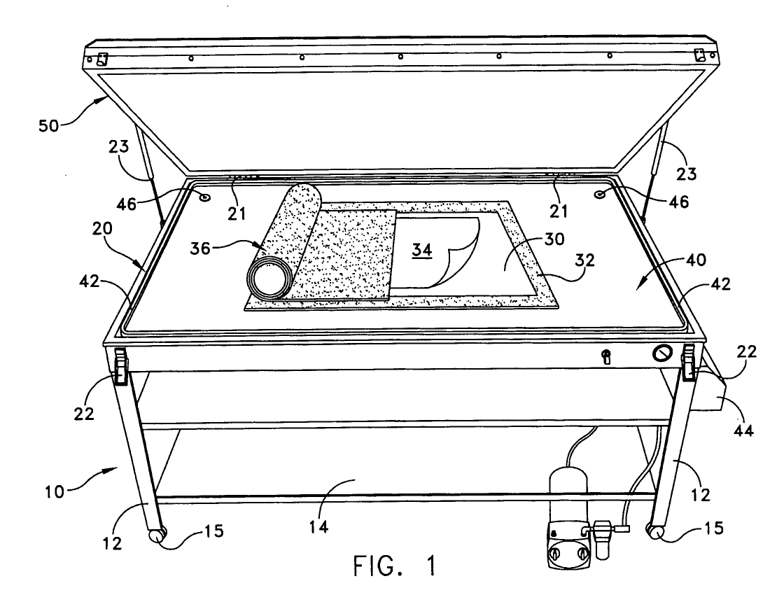

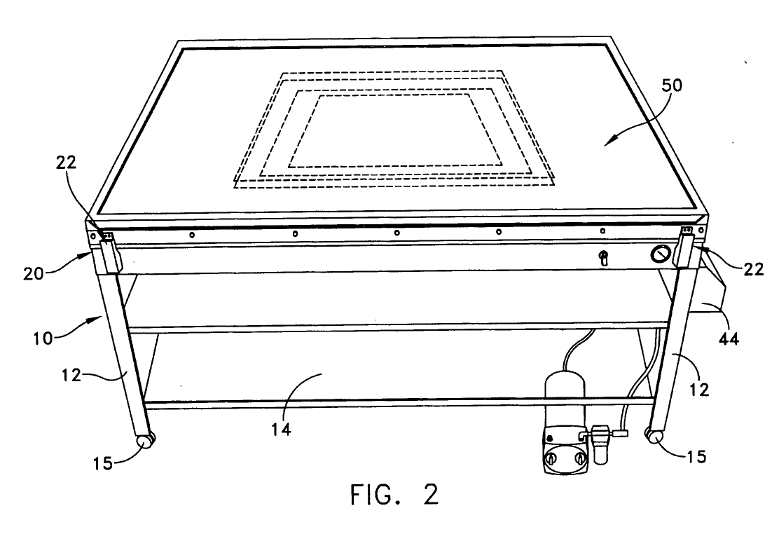

Reference is now made to the drawings for an illustration of one embodiment of the present invention. FIG. 1 illustrates the heat transfer apparatus in an open position while FIG. 2 illustrates the same apparatus in a closed position. The apparatus generally comprises a base 10 that may be in the form of a metal frame work having a plurality of legs 12 and shelving 14. Each of the legs 12 may be supported on a conventional roller 15.

Supported on the base 10 are the upper and lower platen parts. These are illustrated in FIGS. 1 and 2 as lower platen 20 and upper platen 50. The platens 20 and 50 are hingedly connected such as by means of a pair of hinges 21. The upper and lower platens are also preferably secured in their closed position by means of securing clips 22. Struts or absorbers 23 are preferably used to assist in lifting the upper platen relative to the lower platen.

FIG. 1 also illustrates the sheet work piece material shown disposed on the lower platen 20. This includes a receiver material 30 to which the sublimation ink transfer is to be made. The receiver material 30 is placed on the member 32. The member 32 may comprise a heat resistant sheet. In other embodiments the member 32 may comprise a heat resistant board such as a high temperature resistant board that is wrapped with a high temperature resistant fabric such as a nomex cloth which is permanently adhered to the insulating board. The paper 34 that has been imaged with sublimation ink is then interfaced with the receiver layer 30 and a second layer 36 of a high temperature resistant fabric. The layer 36 is illustrated in FIG. 1 in a roll form being rolled out. This may be rolled manually or automatically placed over the sandwich of the sublimation layer 34 and the receiver layer 30.

The upper glass platen 50 is lowered and clamped to the fixed lower rigid platen 20. The platen 20 supports the diaphragm 40. A gasket 42 is mounted at the outer edge perimeter of the diaphragm 40. This provides a seal so that air between the diaphragm and the heated glass platen can be evacuated.

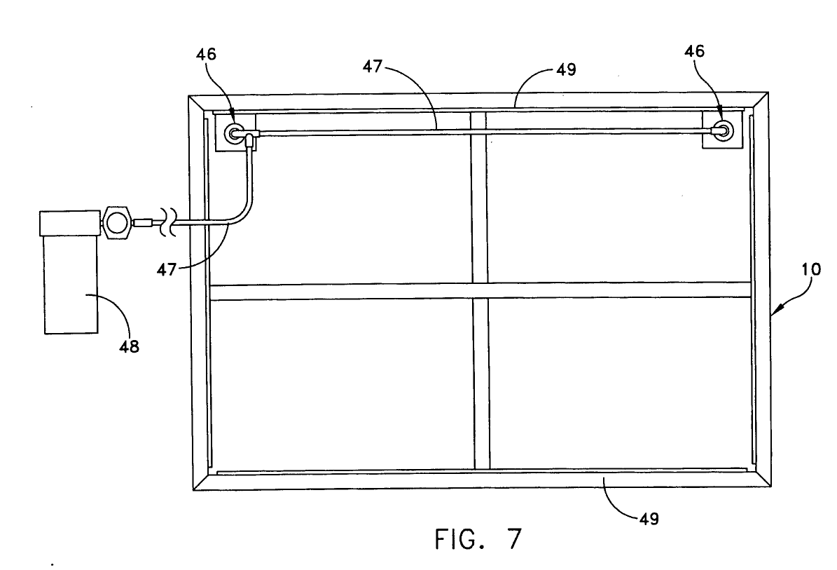

The apparatus of the present invention also includes certain controls for controlling the vacuum and heating processes. This control includes means for activating and deactivating the evacuation process. Refer to the vacuum pump 48 as illustrated in FIG. 7. Various types of control means may be used to control the vacuum pump 48. At the side of the base 10 there is also provided a control panel 44 for indicating certain parameters associated with the apparatus such as the vacuum level and the heat level being applied.

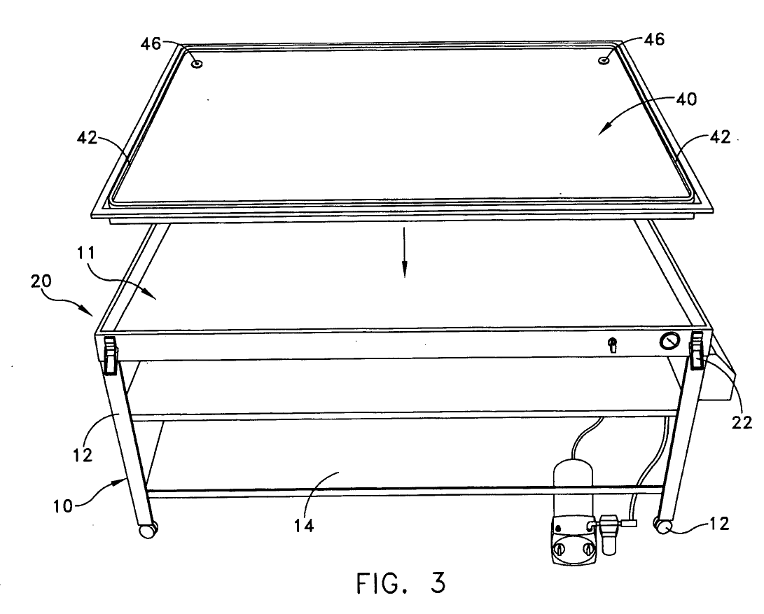

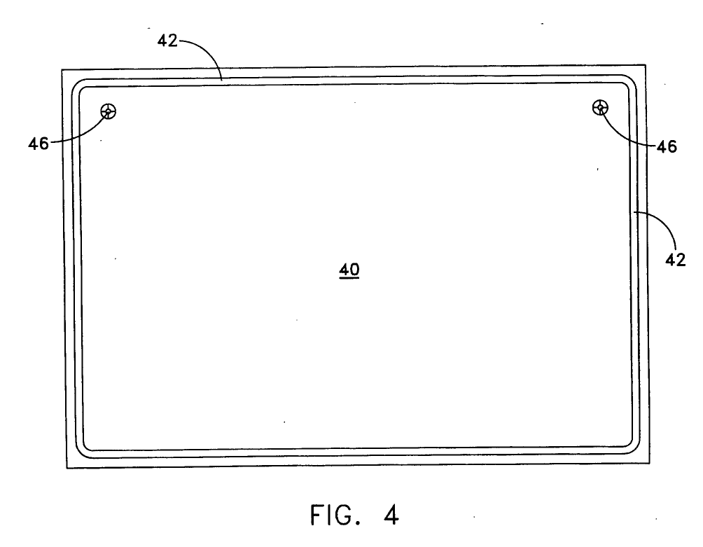

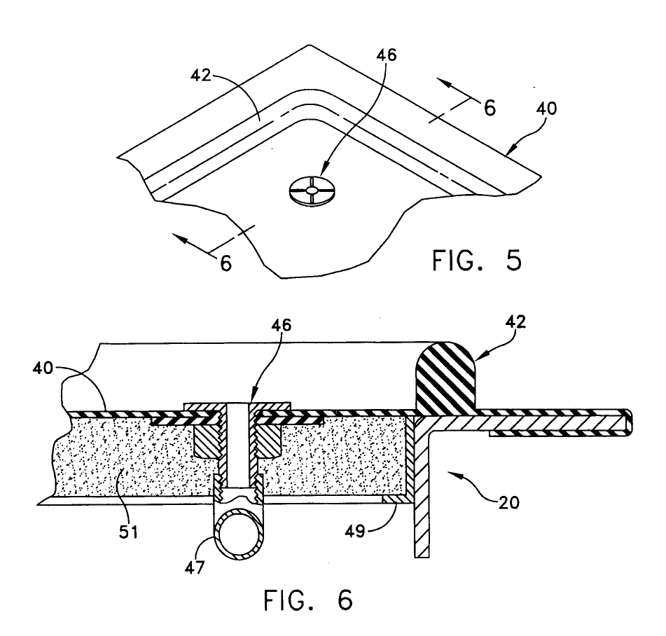

FIG. 3 illustrates the lower platen construction. As indicated in FIG. 3, the base 10 has a top opening 11 into which the diaphragm or blanket 40 is positioned. The walls about the opening 11 may be constructed as a metal frame. Disposed on the metal frame is the diaphragm 40. The diaphragm 40 may be constructed of an EPDM rubber gasket material. FIG. 4 shows a plan view of the diaphragm 40 and FIGS. 5 and 6 illustrate further details. A gasket 42 is disposed peripherally about the diaphragm 40.

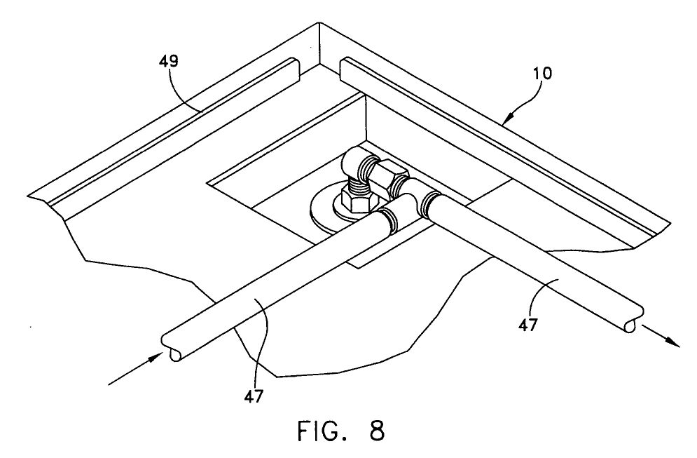

Within the diaphragm 40, such as illustrated in FIGS. 5-8, there are provided vacuum ports 46. Two such vacuum ports are illustrated, for example, in FIG. 1. These ports extend through the flexible diaphragm and connect to vacuum tubing 47. FIG. 7 illustrates this vacuum tubing coupling to a vacuum pump 48 that is controlled to draw a vacuum between the platens via the ports 46. In the illustrated embodiment, two such ports 46 are illustrated, however, it is understood that fewer or greater number of ports may be provided. Also, these ports may be formed in other locations between the platens, or could be provided in either platen.

As illustrated in FIG. 6, the lower platen 20 should preferably include a metal frame 49 and an insulating material 51. The material 51 is non-rigid and is capable of providing heat insulation as well as the capability to deflect as the diaphragm is deflected.

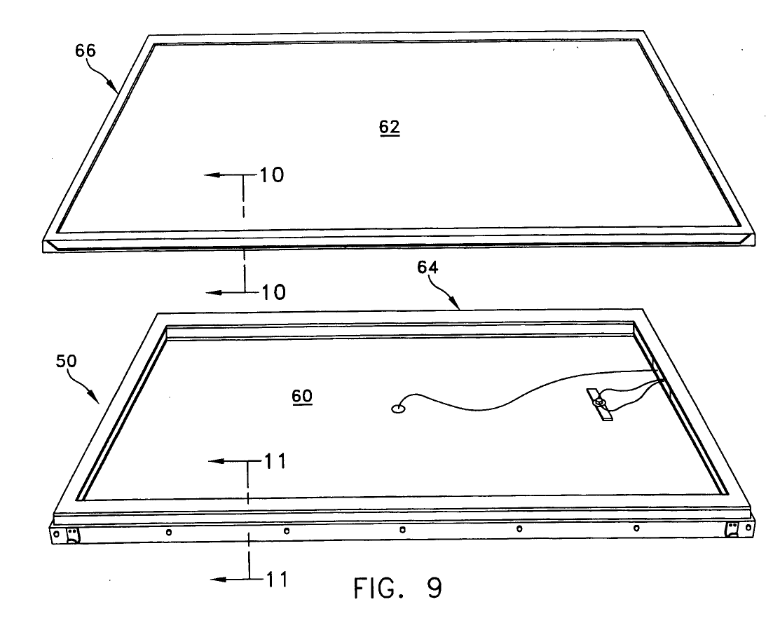

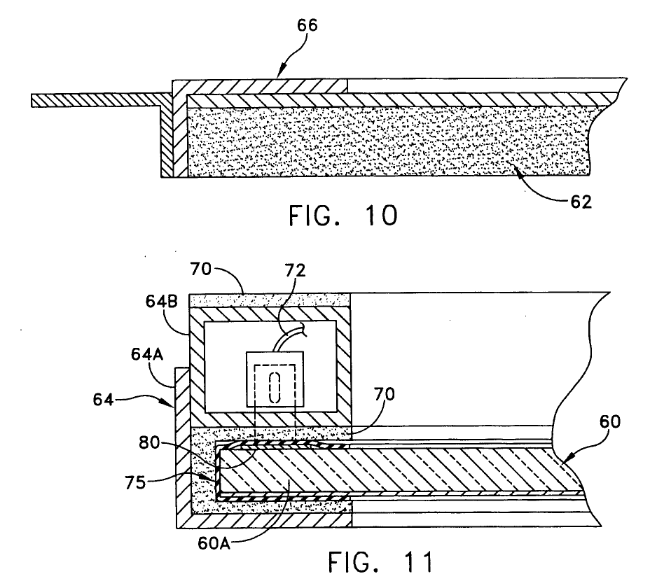

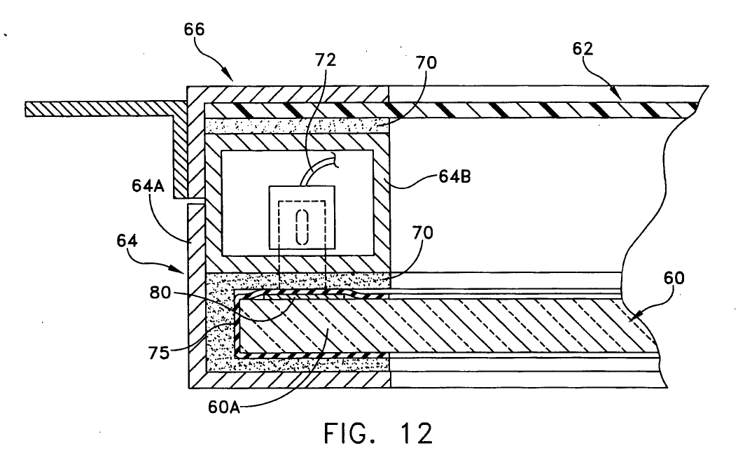

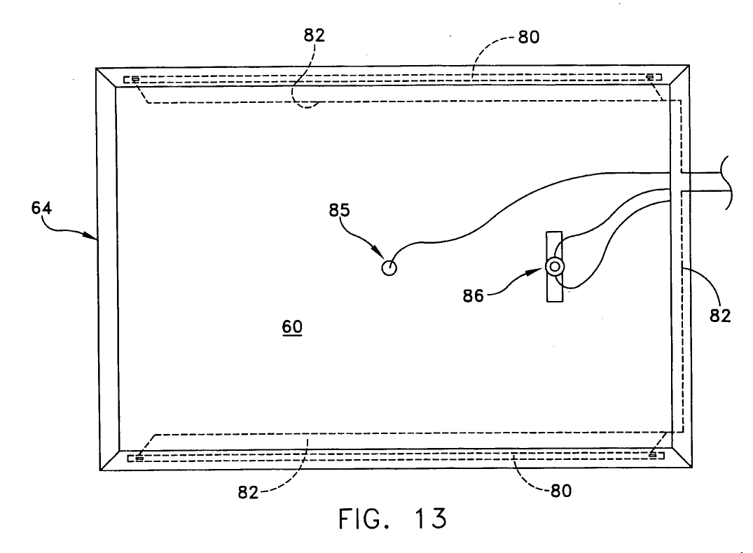

Reference is now made to FIGS. 9-13 for further details of the upper part of platen 50. As illustrated in FIG. 9, this platen may be considered as being comprised of multiple layered components including a glass sheet or member 60 and an insulating layer or sheet 62. The glass sheet 60 is contained within a rectangular-shaped metal frame 64 while the insulating sheet 62 is supported within a rectangular-shaped frame 66. The layer 62 may be attached to the frame 66 in a known manner such as with the use of adhesives or other securing means. The layer 62 provides some heat insulation for the glass sheet 60. The frame 64 may be comprised of separate components 64A and 64B, such as is illustrated in FIG. 11. The frame component 64B may be in the form of a square or rectangular stock. Insulating layers 70 may be provided on the top and bottom surfaces of frame component 64B. The frame component 64B forms a cavity within which electrical wires may be run such as the wire 72 illustrated in FIG. 11. Reference is also made hereinafter to FIG. 13 and the illustration of bus bars and associated electrical wiring thereto. The frame components 64A and 64B may be secured together in a known manner and the insulating members 70 may also be secured to the frame component 64B in a known manner such as with the use of adhesives.

The peripheral edge of the glass sheet 60 is preferably supported by a further insulating member 75. FIG. 11 shows the member 75 extending about the edge area of the glass sheet at edge 60A. FIG. 11 also shows one of the bus bars 80 that is associated with the glass sheet 60.

FIG. 13 illustrates the electrical connections to the glass sheet 60. The bus bars 80 are shown in dotted outline extending along front and back edges of the glass sheet 60. FIG. 13 also illustrates by dotted line the electrical wiring at 82 that couples the bus bars to an energy source (not shown).

The apparatus of the present invention also employs sensors for detecting the temperature at the glass sheet so that the electric heat applied thereto may be controlled. This is illustrated in FIG. 13 by the sensors 85 and 86. These may be in the form of thermocouplers or the like heat sensors for detecting a temperature at the glass sheet material.

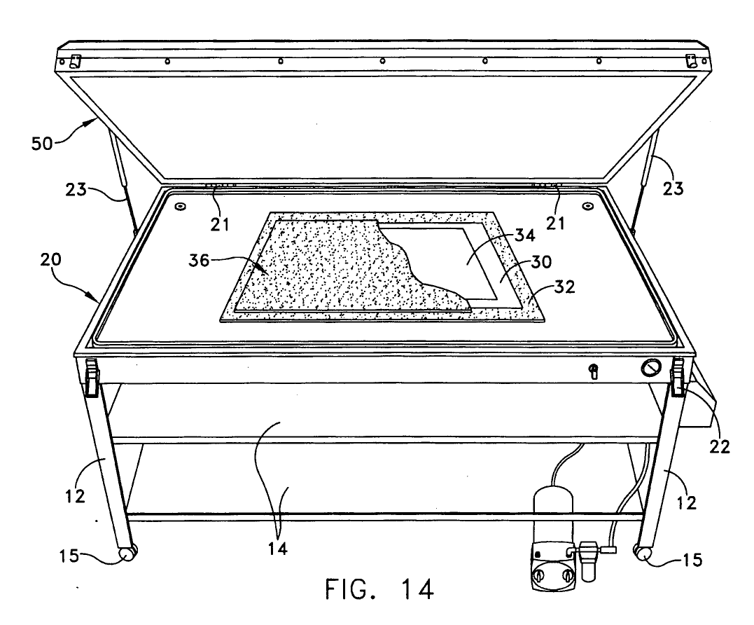

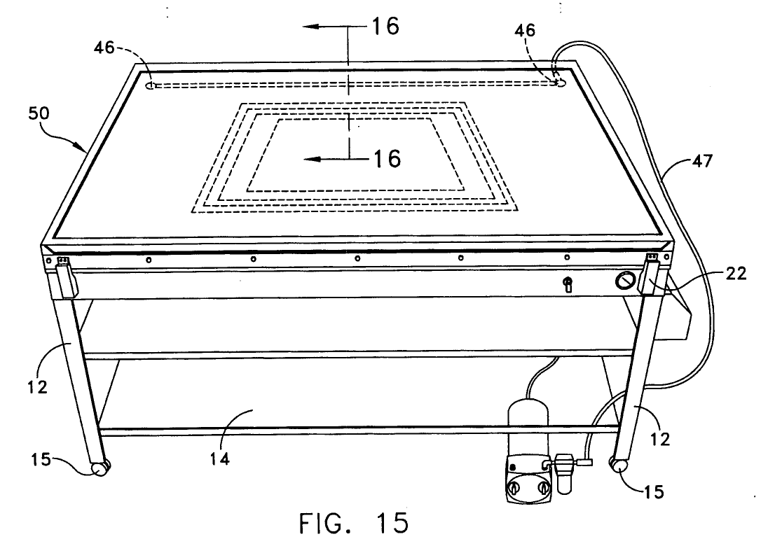

FIG. 14 illustrates the work piece material within the press and with the press in its open position. FIG. 15 shows the same material in place but with the press in a closed position. FIG. 15 also illustrates a vacuum line 47 coupled to ports 46 and controlled from the vacuum pump 48 (see FIG. 7). FIG. 16 is a cross-sectional view showing the details of the press apparatus in its fully closed position. It is noted in FIG. 16 that the gasket 42 is urged against the glass sheet creating a seal. The diaphragm 40 is against the lower side of the receiver sandwich and the glass plate 60 is against the upper side thereof. Arrows 89 illustrate a vacuum being drawn in the space 61 so as to urge the diaphragm 40 firmly against the receiver sandwich.

In the drawings, such as in FIG. 16, the bus bars 80 are indicated associated with the glass sheet 60. These bus bars are typically conductive layers that are fired at a high temperature. These may be constructed of a conductive silver ceramic material. The top surface of the glass sheet is also provided with a conductive coating 90. This conductive coating 90 is integrally formed during the manufacturing process of the glass sheet. The reflective and thermally insulating coating 91 is provided over the layer 90. This is a black and opaque layer 91. This black coating provides a certain amount of thermal insulation and at the same time acts to reflect heat toward the materials in the press which increases the efficiency of the press and preserves energy at the same time.

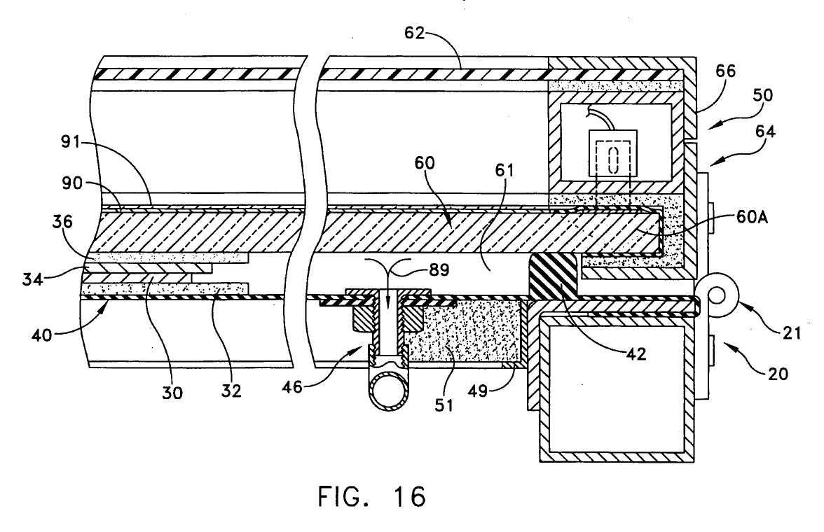

Reference is now made to an alternate embodiment of the present invention in which there is provided a heating strip 92 over the platen 50. This strip 92 is preferably disposed directly over and in contact with the glass member. With respect to, for example the cross-sectional view of FIG. 16 the heating strip may be disposed on the thermally insulating coating 91, but just about the peripheral edge, as illustrated in FIG. 17. Electrical leads 93 are attached to the strip 92 and connect to a source of energy. These strips 92 may be formed of a silicon heat strip or other known types of heating strips may be used to supplement the heating of the glass sheet, particularly at the peripheral edge where it has been found to be most effective.

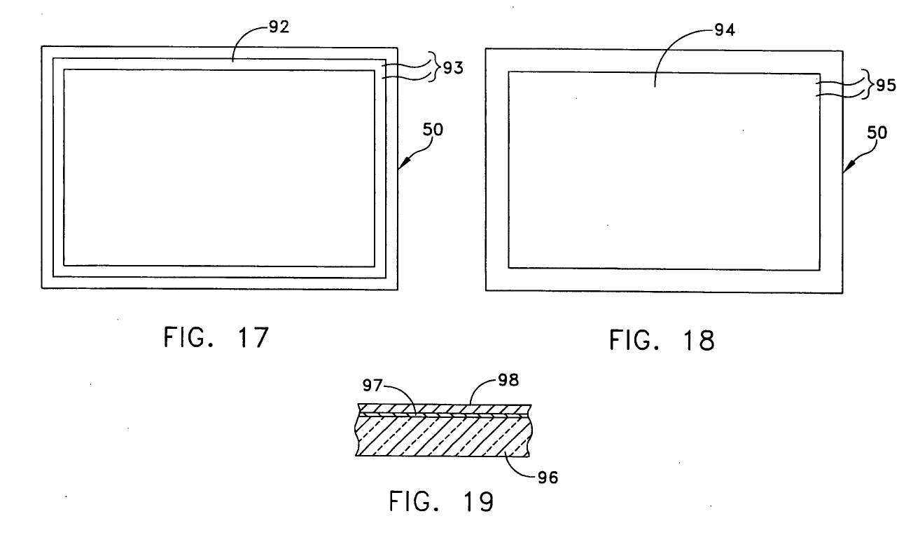

Reference is now made to another embodiment of the present invention in which there is provided a heating blanket 94 over the platen 50. This blanket 94 is preferably disposed directly over and in contact with the glass member. With respect to, for example the cross-sectional view of FIG. 16 the heating blanket may be disposed on the thermally insulating coating 91, and over the entire central area, as illustrated in FIG. 18. Electrical leads 95 are attached to the blanket 94 and connect to a source of energy. The blanket 94 may be formed of a silicon heat material or other known types of heating blankets may be used.

FIG. 19 discloses a section through another version in which the blanket 98 covers the area of the platen as illustrated in FIG. 18, but is used in association with a glass sheet member 96 that is static, or in other words is not excited with any electrical current for direct heating. Instead the heating is provided solely by the rear mounted blanket 98 that is in intimate contact with the opaque layer 97 of the glass sheet member.

While this disclosure has been particularly shown and described with references to preferred embodiments thereof, it will be understood by those skilled in the art that various changes in form and details may be made therein without departing from the spirit and scope of the disclosure as defined by the appended claims.

What is claimed is:

1. A sublimation heat transfer press for transferring a latent image from a dye sublimated printed medium to a receiver medium, said press comprising:
a first platen and a second platen between which is disposed said media and adapted to have open and closed positions therebetween;
said first platen including a heatable glass sheet having a medium contact side and an opposite outer side;
said glass sheet having an electrically conductive coating at said outer side;
an electrical source;
bus bars connecting said electrical source to said electrically conductive coating of said glass sheet;
an opaque reflective heat insulating coating over said electrically conductive coating;
a flexible diaphragm;
and air evacuating means for evacuating air from between the platens in the closed position thereof,
whereby an electric current is passed through said electrically conductive coating, for enabling the glass sheet to be heated by an electric current to provide heat to said media in the press while said reflective heat insulating coating redirects heat toward the media to enhance the heating process;
whereby the flexible diaphragm is able to be flexed against the sheet media to provide substantially even pressure over the surface of the media while heat is applied thereto from the electrically conductive glass sheet.

2. A press according to claim 1 in which the electrically conductive coating is a layer of an electrically conductive metal oxide.

3. A press according to claim 1 in which the diaphragm has associated therewith a peripheral gasket that seals with the glass sheet.

4. A press according to claim 1 in which the first platen is a lower platen, the second platen is an upper platen, the diaphragm is mounted on the lower platen, an-d the electrically conductive glass sheet is mounted on the upper platen.

5. A press according to claim 1 in which the first platen is a lower platen, the second platen is an upper platen, the diaphragm is mounted on the upper platen, and the electrically conductive glass sheet is mounted on the lower platen.

6. A press according to claim 1 and including sealing means for effecting a seal between the platens.

7. A press according to claim 1 in which the air evacuating means comprises a vacuum pump.

8. A press according to claim 1 wherein said reflective heat insulating coating comprises an opaque electrically and thermally insulating layer.

9. A heat transfer press comprising
an upper part which is movable between open and closed conditions;
a lower part;
a flexible diaphragm;
a glass sheet member having an electrically conductive coating on its surface;
first and second elongate, spaced, electrically conductive bus bars on said electrically conductive coating and electrically connected thereto;
a reflective heat insulating coating over said electrically conductive coating;
and air evacuating means for evacuating air from between the upper part and the lower part of the press when the upper part is in its closed condition on the lower part,
whereby an electric current is passed through said electrically conductive coating, for enabling the glass sheet member to be heated by an electric current to provide heat to sheet workpiece material in the press while said reflective heat insulating coating redirects heat toward the sheet workpiece material to enhance the heating process;
whereby the diaphragm is able to be flexed against the sheet workpiece material to provide substantially even pressure over the surface of the sheet workpiece material while heat is applied to the sheet workpiece material from the electrically conductive glass sheet member.

10. A heat transfer press according to claim 9 in which the electrically conductive coating is a layer of an electrically conductive metal oxide.

11. A heat transfer press according to claim 10 in which the electrically conductive metal oxide is fluorine doped tin oxide.

12. A heated vacuum mounting press according to claim 10 in which the diaphragm is mounted on the lower part, and in which the glass sheet member is mounted on the upper part.

13. A heat transfer press according to claim 10 in which the diaphragm is mounted on the upper part, and in which the glass sheet member is mounted on the lower part.

14. A heated vacuum mounting press according to claim 12 and including sealing means for effecting a seal between the upper part and the lower part.

15. A heat transfer press according to claim 10 in which the air evacuating means is a vacuum pump.

16. A heat transfer press according to claim 10 and including aperture means in the electrically conductive glass sheet member through which the air is evacuated by the air evacuating means.

17. A sublimation heat transfer press for transferring a latent image from a dye sublimated printed medium to a receiver medium, said press comprising:
a first platen and a second platen between which is disposed said media and adapted to have open and closed positions therebetween;
said first platen including a heatable glass sheet having a medium contact side and an opposite outer side;
an electrical source;
a reflective heat insulating coating over said heatable glass sheet;
a flexible diaphragm;
an individually heatable member disposed over said glass sheet and excited from said electrical source;
and air evacuating means for evacuating air from between the platens in the closed position thereof,
whereby an electric current is passed through said heatable member, for enabling the glass sheet to be heated by an electric current to provide heat to said media in the press while said reflective heat insulating coating redirects heat toward the media to enhance the heating process;
whereby the flexible diaphragm is able to be flexed against the sheet media to provide substantially even pressure over the surface of the media while heat is applied thereto from the heated glass sheet.

18. A heat transfer press according to claim 17 wherein said individually heatable member comprises a peripheral heat strip.

19. A heated vacuum mounting press according to claim 17 wherein said individually heatable member comprises a heatable blanket that covers the central area of the platen.

20. A heat transfer press according to claim 17 wherein the glass sheet is also directly electrically heated.
